(19) United States
(12) Patent Application Publication
(10) Pub. No.: US 2025/0211975 A1
(43) Pub. Date: Jun. 26, 2025

(54) METHOD AND DEVICE FOR DETERMINING MODEL FOR USE BY TERMINAL

(71) Applicant: Beijing Xiaomi Mobile Software Co., Ltd., Beijing (CN)

(72) Inventor: Yajun ZHU, Beijing (CN)

(73) Assignee: Beijing Xiaomi Mobile Software Co., Ltd., Beijing (CN)

(21) Appl. No.: 18/848,647

(22) PCT Filed: Mar. 31, 2022
(86) PCT No.: PCT/CN2022/084687

§ 371 Date: Sep. 19, 2024

(51) Int. Cl. H04W 8/24

(52) U.S. Cl. CPC H04W 8/245

(57) ABSTRACT

Provided in the present application are a method and device for determining a model for use by a terminal. The method includes: receiving, by a terminal, model indication information from an access network device; and determining, by the terminal, a target model for use by the terminal based on the model indication information.

### CROSS-REFERENCE TO RELATED APPLICATIONS

The present disclosure is the U.S. National phase application of International Application No. PCT/CN2022/084687, filed on Mar. 31, 2022, the entire content of which is incorporated herein by reference for all purposes.

### TECHNICAL FIELD

The present disclosure relates to the field of communication technology and, in particular, to a method and device for determining a model for use by a terminal.

### BACKGROUND

In the related art, it is proposed to use Artificial Intelligence (AI) technology to improve the performance of the new radio. There are various kinds of AI models, which can be used for performance prediction by terminals. For example, in the application of the AI model and beam management, the terminal can use the AI model to predict the optimal beam to be used in the future period of time, without the need for continuous beam measurements. This can reduce the complexity of the measurements by the terminal and can also reduce the signaling overhead.

### SUMMARY

Embodiments of the present disclosure provide a method and device for determining a model for use by a terminal.

In a first aspect, embodiments of the present disclosure provide a method for determining a model for use by a terminal, the method being performed by a terminal, the method including: receiving model indication information from an access network device; and determining, based on the model indication information, a target model for use by the terminal.

In a second aspect, embodiments of the present disclosure provide another method for determining a model for use by a terminal, the method being performed by an access network device, the method including: sending model indication information to the terminal, where the model indication information is configured to indicate a target model for use by the terminal.

In a third aspect, embodiments of the present disclosure provide a communication device capable of implementing some or all of the functions of the terminal in the method described in the first aspect above. For example, the communication device may possess the functions of some or all of the embodiments in the present disclosure, and may also possess the function of implementing any one of the embodiments in the present disclosure independently. The functions can be implemented through hardware, or through hardware executing corresponding software. The hardware or software includes one or more units or modules corresponding to the aforementioned functions.

In one implementation, the communication device may include in its structure a transceiver module and a processing module, the processing module being configured to support the communication device in performing the corresponding functions in the method described above. The transceiver module is used to support communication between the communication device and other devices. The communication device may further include a storage module, the storage module being used for coupling with the transceiver module and the processing module, which stores the necessary computer programs and data of the communication device.

For example, the processing module may be a processor, the transceiver module may be a transceiver or a communication interface, and the storage module may be a memory.

In one implementation, the communication device includes a transceiver module configured to receive model indication information from an access network device; and a processing module configured to determine, based on the model indication information, a target model for use by the terminal.

In a fourth aspect, embodiments of the present disclosure provide another communication device capable of implementing some or all of the functions of the network device in the method example described in the second aspect above. For example, the communication device may possess the functions of some or all of the embodiments in the present disclosure, and may also possess the function of implementing any one of the embodiments in the present disclosure independently. The functions can be implemented through hardware, or through hardware executing corresponding software. The hardware or software includes one or more units or modules corresponding to the aforementioned functions.

In one implementation, the communication device may include in its structure a transceiver module and a processing module, the processing module being configured to support the communication device in performing the corresponding functions in the method described above. The transceiver module is used to support communication between the communication device and other devices. The communication device may further include a storage module, the storage module being used for coupling with the transceiver module and the processing module, which stores the necessary computer programs and data of the communication device.

In one implementation, the communication device includes a transceiver module configured to sending model indication information to the terminal, where the model indication information is configured to indicate a target model for use by the terminal.

In a fifth aspect, embodiments of the present disclosure provide a communication device including a processor that performs the method described in the first aspect above when the processor calls a computer program in a memory.

In a sixth aspect, embodiments of the present disclosure provide a communication device including a processor that performs the method described in the second aspect above when the processor calls a computer program in a memory.

In a seventh aspect, embodiments of the present disclosure provide a communication device including a processor and a memory in which a computer program is stored. The processor executes the computer program stored in the memory to cause the communication device to perform the method described in the first aspect above.

In an eighth aspect, embodiments of the present disclosure provide a communication device including a processor and a memory in which a computer program is stored. The processor executes the computer program stored in the memory to cause the communication device to perform the method described in the second aspect above.

In a ninth aspect, embodiments of the present disclosure provide a communication device including a processor and an interface circuit for receiving a code instruction and transmitting the code instruction to the processor. The processor is used to run the code instruction to cause the device to perform the method described in the first aspect above.

In a tenth aspect, embodiments of the present disclosure provide a communication device including a processor and an interface circuit for receiving a code instruction and transmitting the code instruction to the processor. The processor is used to run the code instruction to cause the device to perform the method described in the second aspect above.

In an eleventh aspect, embodiments of the present disclosure provide a communication system including the communication device described in the third aspect and the communication device described in the fourth aspect, or, alternatively, the communication device described in the fifth aspect and the communication device described in the sixth aspect, or, alternatively, the communication device described in the seventh aspect and the communication device described in the eighth aspect, or, alternatively, the communication device described in the ninth aspect and the communication device described in the tenth aspect.

In a twelfth aspect, embodiments of the present disclosure provide a non-transitory computer-readable storage medium for storing instructions for use by the terminal, which, when the instructions are executed, cause the terminal to perform the method described in the first aspect above.

In a thirteenth aspect, embodiments of the present disclosure provide a non-transitory computer-readable storage medium for storing instructions for use by the access network device, which, when the instructions are executed, cause the access network device to perform the method described in the second aspect above.

In a fourteenth aspect, the present disclosure further provides a computer program product including a computer program that, when run on a computer, causes the computer to perform the method described in the first aspect above.

In a fifteenth aspect, the present disclosure further provides a computer program product including a computer program that, when run on a computer, causes the computer to perform the method described in the second aspect above.

In a sixteenth aspect, the present disclosure provides a chip system including at least one processor and an interface for supporting a terminal in implementing the functions involved in the first aspect, for example, determining or processing at least one of the data and information involved in the method described above. In one possible design, the chip system further includes a memory for storing the necessary computer programs and data of the terminal. The chip system may consist of a chip or may include a chip and other discrete devices.

In a seventeenth aspect, the present disclosure provides a chip system including at least one processor and an interface for supporting an access network device in implementing the functions involved in the second aspect, for example, determining or processing at least one of the data and information involved in the method described above. In one possible design, the chip system further includes a memory for storing the necessary computer programs and data of the terminal. The chip system may consist of a chip or may include a chip and other discrete devices.

In an eighteenth aspect, the present disclosure provides a computer program that, when run on a computer, causes the computer to perform the method described in the first aspect above.

In a nineteenth aspect, the present disclosure provides a computer program that, when run on a computer, causes the computer to perform the method described in the second aspect above.

### BRIEF DESCRIPTION OF THE DRAWINGS

In order to more clearly illustrate the technical solutions in the embodiments or background art of the present disclosure, the accompanying drawings to be used in the embodiments or background art of the present disclosure will be described below.

FIG. 1 is an architectural diagram of a communication system provided by embodiments of the present disclosure.

FIG. 2 is a flowchart of a method for determining a model for use by a terminal provided by embodiments of the present disclosure.

FIG. 3 is a flowchart of another method for determining a model for use by a terminal provided by embodiments of the present disclosure.

FIG. 4 is a flowchart of yet another method for determining a model for use by a terminal provided by embodiments of the present disclosure.

FIG. 5 is a flowchart of yet another method for determining a model for use by a terminal provided by embodiments of the present disclosure.

FIG. 6 is a structural diagram of a communication device provided by embodiments of the present disclosure.

FIG. 7 is a structural diagram of another communication device provided by embodiments of the present disclosure.

FIG. 8 is a schematic diagram of a structure of a chip provided by embodiments of the present disclosure.

### DETAILED DESCRIPTION

In order to better understand a method and apparatus for determining a model for use by a terminal disclosed in embodiments of the present disclosure, a communication system to which the embodiments of the present disclosure apply is first described below.

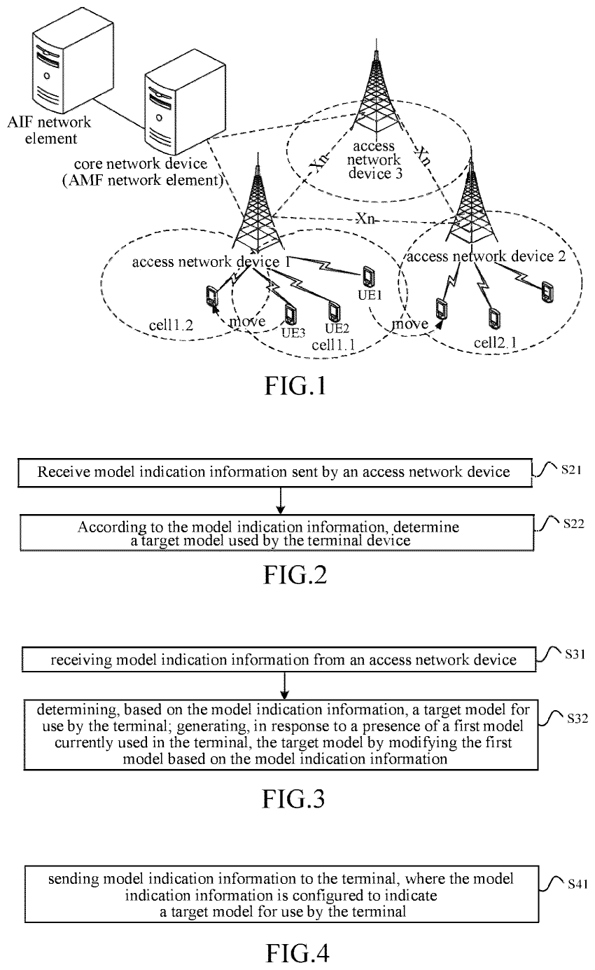

Referring to FIG. 1, FIG. 1 is a schematic diagram of a communication system provided by embodiments of the present disclosure. As shown in FIG. 1, the communication system may include access network devices, a plurality of terminals, and a core network device. One access network device and another access network device communicate with each other by wired or wireless means, e.g., through the Xn interface in FIG. 1. The access network device may cover one or more cells. For example, access network device 1 covers cell 1.1 and cell 1.2, and access network device 2 covers cell 2.1. The terminal may reside in the access network device in one of the cells and be in a connected state. Further, the terminal may transition from the connected state to an inactive state, i.e., to the unconnected state, through a radio resource control (RRC) release procedure. The terminal in the unconnected state may reside in the original cell and perform uplink transmissions and/or downlink transmissions with the access network device in the original cell based on the transmission parameters of the terminal in the original cell. The terminal in the unconnected state may also move to a new cell and perform uplink transmissions and/or downlink transmissions with the access network device in the new cell based on the transmission parameters of the terminal in the new cell.

It should be noted that FIG. 1 is only an exemplary framework diagram, and the number of nodes, the number of cells, and the state of the terminal included in FIG. 1 are not limited. In addition to the functional nodes shown in FIG. 1, other nodes, such as a core network device, a gateway device, an application server, and the like, may be included without limitation. The access network device communicates with the core network device through wired or wireless means, such as communicating with each other through a next generation (NG) interface.

The access network device is mainly used to implement at least one of the following functions of the terminal: resource scheduling, wireless resource management, or wireless resource control. Specifically, the access network devices may include a base station, a wireless access point, a transmission reception point (TRP), a transmission point (TP), and any one of some other access nodes. In the embodiments of the present disclosure, the device for implementing the function of the access network device may be an access network device itself, or a device, such as a chip system or system-on-chip, that can support the access network device to implement its function, which may be mounted in the access network device or used in conjunction with the access network device. In the technical solutions provided by the embodiments of the present disclosure, the technical solutions provided by the embodiments of the present disclosure are described using an example where the device for implementing the function of the access network device is an access network device.

The core network device may include an Access and Mobility Management Function (AMF) and/or a location management function network element. Optionally, the location management function network element includes a location server, and the location server may be implemented as any of the following: Location Management Function (LMF), Enhanced Serving Mobile Location Centre (E-SMLC), Secure User Plane Location (SUPL), or SUPL Location Platform (SUPL SLP).

Terminal equipment/device is an entity on the user side that is used to receive or transmit signals, such as a mobile phone. The terminal equipment/device can also be referred to as the terminal, user equipment (UE), mobile station (MS), mobile terminal (MT), and the like. The terminal can be a car with communication functions, an intelligent car, a mobile phone, a wearable device, a Pad, a computer with wireless transceiver capabilities, a virtual reality (VR) terminal, an augmented reality (AR) terminal, wireless terminal equipment used in industrial control, wireless terminal equipment in unmanned (self-driving) technology, wireless terminal equipment in remote medical surgery, wireless terminal equipment in smart grid, wireless terminal equipment in transportation safety, wireless terminal equipment in smart city, wireless terminal equipment in smart home, and so on. The embodiments of the present disclosure do not limit the specific technologies and specific equipment forms used for the terminals.

The AMF network element is mainly responsible for access authentication of the terminal, mobility management, signaling interaction between various functional network elements, etc. For example, it can manage a user registration state, user connection state, user registration into the network, tracking area update, user authentication for cell switching, key security, and so on.

An Artificial Intelligence Function (AIF) network element, which is connected to the core network device (AMF network element) through a wired or wireless interface, is mainly responsible for the training of AI model parameters.

It should be noted that the technical solutions of the embodiments of the present disclosure can be applied to various communication systems, e.g., a long term evolution (LTE) system, a 5th generation (5G) mobile communication system, a 5G new radio (NR) system, or other future new mobile communication systems.

It can be understood that the description of the communication system in the embodiments of the present disclosure is intended to more clearly illustrate the technical solutions of the embodiments of the present disclosure and does not constitute a limitation of the technical solutions provided by the embodiments of the present disclosure. A person of ordinary skill in the art may know that, with the evolution of the system architecture and the emergence of new business scenarios, the technical solutions provided by the embodiments of the present disclosure are equally applicable to similar technical problems.

It should be noted that the “time unit” in the embodiments of the present disclosure may be a physical time unit or a logical time unit, for example, in units of seconds, milliseconds, microseconds, frames, subframes, slots, mini-slots, orthogonal frequency division multiplexing (OFDM) symbols, etc.

In view of the above, the embodiments of the present disclosure provide a method and apparatus for determining a model for use by a terminal to at least address problems in the related art.

Referring to FIG. 2, FIG. 2 is a flowchart of a method for determining a model for use by a terminal provided by embodiments of the present disclosure.

As shown in FIG. 2, the method is applied to a terminal, and the method may include, but is not limited to, the following steps.

The first step S21 is receiving model indication information from an access network device.

It can be understood that AI is a method of teaching the same thing to a computer, which is the concept of mimicking human abilities. AI may encompass a variety of models, for example, machine learning models, deep learning models, federated learning models, etc. Each model also includes various types of sub-models. For example, the deep learning models include convolutional neural networks, recurrent neural networks, etc. Here, the model type does not distinguish between models or sub-models.

In the embodiment of the present disclosure, the terminal receives model indication information sent by the access network device, where the model indication information may indicate information related to a model for use by the terminal. For example, the model indication information indicates that a first terminal uses a deep learning model, etc., or the model indication information indicates relevant parameters of the model used by the first terminal, etc.

The next step S22 is determining, based on the model indication information, a target model for use by the terminal.

In the embodiment of the present disclosure, the terminal receives model indication information sent by the access network device, and may determine a target model for use by the terminal, where the model indication information may indicate information related to a model for use by the terminal.

In an exemplary embodiment, where one or more models (including a deep learning model) are pre-stored in the terminal, if the model indication information sent by the access network device indicates that a first terminal uses a deep learning model, the terminal may determine that the target model for use is a deep learning model.

In the embodiment of the present disclosure, the pre-stored model in the terminal may be inherent to the terminal, or predefined, or generated based on the model indication information last sent by the access network device, or obtained through training by the terminal, or obtained through joint training by the terminal and the access network device.

In another exemplary embodiment, the model indication information sent by the access network device indicates parameter information for the first terminal to use a deep learning model. Upon receiving the model indication information sent by the access network device, the terminal may perform initial configuration of the model based on the parameter information of the deep learning model, obtain the deep learning model, and use it as the target model.

In some embodiments, the model indication information includes model parameter information, the model parameter information including at least one of the following:
a model type parameter;
the number of network layers;
the number of neuron nodes in each network layer;
a computation parameter matrix parameter of a neuron node;
a bias parameter of the neuron node;
an activation function parameter of the neuron node;
a stride parameter; or
a padding value parameter.

In the embodiment of the present disclosure, the model indication information sent by the access network device to the terminal includes the model parameter information, and the model parameter information includes one or more of the following parameters: a model type parameter, the number of network layers, the number of neuron nodes in each network layer, a computation parameter matrix parameter of a neuron node, a bias parameter of the neuron node, an activation function parameter of the neuron node, a stride parameter, or a padding value parameter.

The model type parameter is used to indicate a type of the model for use by the terminal. In the case where one or more models are pre-stored in the terminal, the terminal may determine, based on the model type parameter, a target model to be used. The number of network layers is used to indicate the number of network layers of the model for use by the terminal. In the case where one or more network layer structures of the models are pre-stored in the terminal, the terminal may determine, based on the number of network layers, to select a combination of network layer structures corresponding to the number of network layers as the target model to be used. The number of neuron nodes in each network layer is used to indicate the number of neuron nodes in each network layer of the model for use by the terminal. The computation parameter matrix parameter of the neuron node is used to indicate a computation parameter matrix of the neuron node of the model for use by the terminal. The bias parameter of the neuron node is used to indicate a bias of the neuron node of the model for use by the terminal. The activation function parameter of the neuron node is used to indicate the activation function of the neuron node of the model for use by the terminal. The stride parameter is used to indicate a stride or strides of the model for use by the terminal. The padding value parameter is used to indicate the padding value of the model for use by the terminal.

In the exemplary embodiment, the model indication information sent by the access network device to the terminal includes model parameter information, and the model parameter information includes: a model type parameter and a computation parameter matrix parameter of a neuron node. In the embodiment of the present disclosure, a type of the model can be determined based on the model type parameter, and further, a computation parameter matrix of the neuron node of the model can be determined. For example, when the model type parameter indicates that the model is a convolutional neural network model, and the computation parameter matrix parameter of the neuron node is a convolution kernel, the convolution kernel of the convolutional neural network model can be determined.

It should be noted that for different model types, the required model parameter information may be different, and the above examples are only for illustrative purposes, and the embodiments of the present disclosure do not impose specific limitations thereon.

In some embodiments, S21, receiving the model indication information from the access network device, includes:
receiving a broadcast message of the access network device, where the broadcast message includes the model indication information;
or, receiving a unicast message of the access network device, where the unicast message includes the model indication information;
or, receiving a multicast message of the access network device, where the multicast message includes the model indication information.

In these embodiments of the present disclosure, the terminal receives the model indication information sent by the access network device, and may receive the model indication information by receiving a broadcast message, a unicast message, or a multicast message of the access network device.

In the case where the terminal is a specific terminal, the access network device may send a unicast message to the terminal that is a specific terminal. In the case where the terminal belongs to a specific group of terminals, the access network device may send a multicast message to the terminal that belongs to the specific group of terminals, whereby the terminal may receive the model indication information sent by the access network device.

In some embodiments, receiving the broadcast message of the access network device includes: receiving a System Information Block (SIB) of the access network device, where the SIB includes the model indication information.

The SIB of the access network device may be an existing SIB or a newly configured SIB. The newly configured SIB is used to send the model indication information.

In these embodiments of the present disclosure, the broadcast message of the access network device may be a SIB, and the terminal can obtain the model indication information by receiving the SIB.

In some embodiments, receiving the unicast message or multicast message of the access network device includes:
receiving media access control control unit (MAC CE) signaling of the access network device, where the MAC CE signaling includes the model indication information;
or, receiving radio resource control (RRC) signaling of the access network device, where the RRC signaling includes the model indication information;
or, receiving downlink control information (DCI) signaling of the access network device, where the DCI signaling includes the model indication information.

In these embodiments of the present disclosure, the unicast message of the access network device may be MAC CE signaling, RRC signaling, or DCI signaling. After the MAC CE signaling, RRC signaling, or DCI signaling is received, the terminal can obtain the model indication information.

In some embodiments, the method for determining a model for use by a terminal provided by embodiments of the present disclosure further includes: determining an effective time for the target model, where the effective time is a time X plus N time units, the time X being a time when the model indication information is received from the access network device, N being greater than or equal to 0.

In these embodiments of the present disclosure, after the model indication information sent by the access network device is received, the terminal determines a target model to be used, and can further determine a time when the target model is to take effect.

In an exemplary embodiment, the terminal receives the model indication information sent by the access network device, determines a target model to be used, and determines that the target model takes effect immediately. The terminal determines that the effective time of the target model is a time when the model indication information sent by the access network device is received.

In another exemplary embodiment, the terminal receives the model indication information sent by the access network device, determines a target model to be used, and determines that the target model takes effect immediately after N time units. For example, when N time units are 2 slots, the terminal determines that the effective time of the target model is a time X plus 2 slots, the time X being a time when the model indication information sent by the access network device is received.

In these embodiments of the present disclosure, after a unicast message, a multicast message, or a broadcast message that includes the model indication information sent by the access network device is received, the terminal determines a target model to be used, and determines that the target model takes effect immediately. Alternatively, the terminal device determines that the effective time of the target model is a time X plus N time units, the time X being a time when the unicast message, the multicast message, or the broadcast message sent by the access network device is received.

In some embodiments of the present disclosure, the N time units may be predefined, or determined based on relevant information of the access network device, or determined based on the communication protocol, and the embodiments of the present disclosure do not specifically limit this.

The broadcast message may be a SIB. The unicast message or multicast message may be the MAC CE signaling, RRC signaling, or DCI signaling.

Exemplarily, after the SIB including the model indication information sent by the access network device is received, the terminal determines the target model to be used, and determines that the target model takes effect immediately. Alternatively, the terminal determines that the effective time of the target model is a time X plus N time units, the time X being a time when the SIB sent by the access network device is received.

Exemplarily, after the MAC CE signaling including the model indication information sent by the access network device is received, the terminal determines the target model to be used, and determines that the target model takes effect immediately. Alternatively, the terminal determines that the effective time of the target model is a time X plus N time units, the time X being a time when the MAC CE signaling sent by the access network device is received.

In some embodiments, the method for determining a model for use by a terminal provided by embodiments of the present disclosure further includes: determining an effective time of the target model, where the effective time is a first moment that occurs after a moment when the terminal sends an acknowledgement character (ACK) in feedback of the MAC CE signaling, the RRC signaling, or the DCI signaling plus a preset length of time.

In these embodiments of the present disclosure, after the model indication information sent by the access network device is received, the terminal determines a target model to be used, and can further determine a time when the target model is to take effect.

After the MAC CE signaling including the model indication information sent by the access network device is received, the terminal may provide feedback by sending an acknowledgement character (ACK) to the access network device. In the embodiment of the present disclosure, the terminal may determine that the effective time of the target model is a first moment that occurs after adding a preset length of time to a moment when the terminal sends the acknowledgement character (ACK).

After the DCI signaling including the model indication information sent by the access network device is received, the terminal may perform Hybrid Automatic Repeat Request (HARQ)-ACK feedback and sends an acknowledgement character (ACK) to the access network device. In the embodiment of the present disclosure, the terminal may determine that the effective time of the target model is the first moment that occurs after the moment when the acknowledgement character (ACK) is sent plus the preset length of time.

In some embodiments of the present disclosure, the preset length of time may be predefined, or determined based on relevant information of the access network device, or determined based on the communication protocol, and the embodiments of the present disclosure do not specifically limit this.

In some embodiments, the method for determining a model for use by a terminal provided by embodiments of the present disclosure, further includes: determining an effective time for the target model by:
determining the effective time for the target model based on an effective time parameter and a time when the MAC CE signaling is received, where the MAC CE signaling carries the effective time parameter;
determining the effective time for the target model based on an effective time parameter and a time when the RRC signaling is received, where the RRC signaling carries the effective time parameter;
determining the effective time for the target model based on an effective time parameter and a time when the DCI signaling is received, where the DCI signaling carries the effective time parameter.

In these embodiments of the present disclosure, after the model indication information sent by the access network device is received, the terminal determines a target model to be used, and can further determine a time when the target model is to take effect.

The MAC CE signaling carries an effective time parameter. After the MAC CE signaling including the model indication information sent by the access network device is received, the terminal determines the effective time for the target model based on the effective time parameter and the time when the MAC CE signaling is received.

Exemplarily, when an effective time parameter carried in the MAC CE signaling is 1, and the time when the MAC CE signaling is received by the terminal is X, the effective time of the target model is determined to be X+1 slots. Alternatively, when an effective time parameter carried in the MAC CE signaling is 3, and the time when the MAC CE signaling is received by the terminal is X, the effective time of the target model is determined to be X+3 seconds.

The RRC signaling carries an effective time parameter. After the RRC signaling including the model indication information sent by the access network device is received, the terminal determines the effective time of the target model based on the effective time parameter and the time when the RRC signaling is received.

Exemplarily, when an effective time parameter carried in the RRC signaling is 1, and the time when the RRC signaling is received by the terminal is X, the effective time of the target model is determined to be X+1 slots. Alternatively, when an effective time parameter carried in the RRC signaling is 2, and the time when the RRC signaling is received by the terminal is X, the effective time of the target model is determined to be X+2 milliseconds.

The DCI signaling carries an effective time parameter. After the DCI signaling including the model indication information sent by the access network device is received, the terminal determines the effective time of the target model based on the effective time parameter and the time when the DCI signaling is received.

Exemplarily, when an effective time parameter carried in the DCI signaling is 2, and the time when the DCI signaling is received by the terminal is X, the effective time of the target model is determined to be X+2 slots.

It should be noted that the above examples are for illustrative purposes only and are not to be taken as a specific limitation on the embodiments of the present disclosure. The effective time parameter may be other values. The effective time of the target model may also be determined as the time when the model indication information is received, plus the frame, subframe, mini-slot, or symbol, etc., of the effective time parameter.

Referring to FIG. 3, FIG. 3 is a flowchart of another method for determining a model for use by a terminal provided by embodiments of the present disclosure.

As shown in FIG. 3, the method is applied to a terminal, and the method may include, but is not limited to, the following steps.

The first step S31 is receiving model indication information from an access network device.

It can be understood that AI is a method of teaching the same thing to a computer, which is the concept of mimicking human abilities. AI may encompass a variety of models, for example, machine learning models, deep learning models, federated learning models, etc.

In the embodiment of the present disclosure, the terminal receives model indication information sent by the access network device, where the model indication information may indicate information related to a model for use by the terminal. For example, the model indication information indicates that a first terminal uses a deep learning model, etc., or the model indication information indicates relevant parameters of the model used by the first terminal, etc.

The next step S32 is determining, based on the model indication information, a target model for use by the terminal; and generating, in response to a presence of a first model currently used in the terminal, the target model by modifying the first model based on the model indication information.

In the embodiment of the present disclosure, the terminal receives the model indication information sent by the access network device, and determines the target model to be used. If, at this time, there exists a first model currently used in the terminal, the first model may be modified to generate the target model.

In some embodiments, the first model currently used in the terminal is inherent to the terminal, or predefined, or generated based on the model indication information last sent by the access network device, or obtained through training by the terminal, or obtained by joint training by the terminal and the access network device.

In some embodiments, the model indication information includes model parameter information, the model parameter information including at least one of the following:
a model type parameter;
the number of network layers;
the number of neuron nodes in each network layer;
a computation parameter matrix parameter of a neuron node;
a bias parameter of the neuron node;
an activation function parameter of the neuron node;
a stride parameter; or
a padding value parameter.

In the embodiment of the present disclosure, the model indication information sent by the access network device to the terminal includes the model parameter information, and the model parameter information includes one or more of the following parameters: a model type parameter, the number of network layers, the number of neuron nodes in each network layer, a computation parameter matrix parameter of a neuron node, a bias parameter of the neuron node, an activation function parameter of the neuron node, a stride parameter, or a padding value parameter.

The model type parameter is used to indicate a type of the model for use by the terminal. In the case where one or more models are pre-stored in the terminal, the terminal may determine, based on the model type parameter, a target model to be used. The number of network layers is used to indicate the number of network layers of the model for use by the terminal. In the case where one or more network layer structures of the models are pre-stored in the terminal, the terminal may determine, based on the number of network layers, to select a combination of network layer structures corresponding to the number of network layers as the target model to be used. The number of neuron nodes in each network layer is used to indicate the number of neuron nodes in each network layer of the model for use by the terminal. The computation parameter matrix parameter of the neuron node is used to indicate a computation parameter matrix of the neuron node of the model for use by the terminal. The bias parameter of the neuron node is used to indicate a bias of the neuron node of the model for use by the terminal. The activation function parameter of the neuron node is used to indicate the activation function of the neuron node of the model for use by the terminal. The stride parameter is used to indicate a stride or strides of the model for use by the terminal. The padding value parameter is used to indicate the padding value of the model for use by the terminal.

In the exemplary embodiment, the model indication information sent by the access network device to the terminal includes model parameter information, and the model parameter information includes: a model type parameter and a computation parameter matrix parameter of a neuron node. In the embodiment of the present disclosure, a type of the model can be determined based on the model type parameter, and further, a computation parameter matrix of the neuron node of the model can be determined. For example, when the model type parameter indicates that the model is a convolutional neural network model, and the computation parameter matrix parameter of the neuron node is a convolution kernel, the convolution kernel of the convolutional neural network model can be determined.

It should be noted that for different model types, the required model parameter information may be different, and the above examples are only for illustrative purposes, and the embodiments of the present disclosure do not impose specific limitations thereon.

In some embodiments, S31, receiving the model indication information from the access network device, including:
receiving a broadcast message of the access network device, where the broadcast message includes the model indication information;
or, receiving a unicast message of the access network device, where the unicast message includes the model indication information;
or, receiving a multicast message of the access network device, where the multicast message includes the model indication information.

In these embodiments of the present disclosure, the terminal receives the model indication information sent by the access network device, and may receive the model indication information by receiving a broadcast message, a unicast message, or a multicast message of the access network device.

In the case where the terminal is a specific terminal, the access network device may send a unicast message to the terminal that is a specific terminal. In the case where the terminal belongs to a specific group of terminals, the access network device may send a multicast message to the terminal that belongs to the specific group of terminals, whereby the terminal may receive the model indication information sent by the access network device.

In some embodiments, receiving the broadcast message of the access network device includes: receiving a System Information Block (SIB) of the access network device, where the SIB includes the model indication information.

The System Information Block (SIB) of the access network device may be an existing SIB or a newly configured SIB. The newly configured SIB is used to send the model indication information.

In these embodiments of the present disclosure, the broadcast message of the access network device may be a SIB, and the terminal can obtain the model indication information by receiving the SIB.

In some embodiments, receiving the unicast message or multicast message of the access network device includes:
receiving media access control control unit (MAC CE) signaling of the access network device, where the MAC CE signaling includes the model indication information;
or, receiving radio resource control (RRC) signaling of the access network device, where the RRC signaling includes the model indication information;
or, receiving downlink control information (DCI) signaling of the access network device, where the DCI signaling includes the model indication information.

In these embodiments of the present disclosure, the unicast message of the access network device may be MAC CE signaling, RRC signaling, or DCI signaling. After the MAC CE signaling, RRC signaling, or DCI signaling is received, the terminal can obtain the model indication information.

It should be noted that S31 and S32 may be implemented separately or in combination with any of the other steps in the embodiments of the present disclosure, for example, in combination with S21 and S22 in the embodiments of the present disclosure, and the embodiments of the present disclosure do not limit this. It should be noted that the information contained in S31 and S32 is not required to be identical, i.e., S32 may modify only a portion of the parameters determined in S31, or S32 may include parameters not contained in S31, etc.

Referring to FIG. 4, FIG. 4 is a flowchart of yet another method for determining a model for use by a terminal provided by embodiments of the present disclosure.

As shown in FIG. 4, the method is applied to an access network device, and the method may include, but is not limited to, the following steps.

The first step S41 is sending model indication information to the terminal, where the model indication information is configured to indicate a target model for use by the terminal.

It can be understood that AI is a method of teaching the same thing to a computer, which is the concept of mimicking human abilities. AI may encompass a variety of models, for example, machine learning models, deep learning models, federated learning models, etc.

In the embodiment of the present disclosure, the terminal receives model indication information sent by the access network device, where the model indication information may indicate information related to a model for use by the terminal. For example, the model indication information indicates that a first terminal uses a deep learning model, etc., or the model indication information indicates relevant parameters of the model used by the first terminal, etc.

In the embodiment of the present disclosure, the terminal receives model indication information sent by the access network device, and can determine a target model to be used, where the model indication information may indicate information related to a model for use by the terminal.

In an exemplary embodiment, where one or more models (including a deep learning model) are pre-stored in the terminal, if the model indication information sent by the access network device indicates that a first terminal uses a deep learning model, the terminal may determine that the target model for use is a deep learning model.

In the embodiment of the present disclosure, the pre-stored model in the terminal may be inherent to the terminal, or predefined, or generated based on the model indication information last sent by the access network device, or obtained through training by the terminal, or obtained through joint training by the terminal and the access network device.

In another exemplary embodiment, the model indication information sent by the access network device indicates parameter information for the first terminal to use a deep learning model. Upon receiving the model indication information sent by the access network device, the terminal may perform initial configuration of the model based on the parameter information of the deep learning model, obtain the deep learning model, and use it as the target model.

In some embodiments, the model indication information includes model parameter information, the model parameter information including at least one of the following:
a model type parameter;
the number of network layers;
the number of neuron nodes in each network layer;
a computation parameter matrix parameter of a neuron node;
a bias parameter of the neuron node;
an activation function parameter of the neuron node;
a stride parameter; or
a padding value parameter.

In the embodiment of the present disclosure, the model indication information sent by the access network device to the terminal includes the model parameter information, and the model parameter information includes one or more of the following parameters: a model type parameter, the number of network layers, the number of neuron nodes in each network layer, a computation parameter matrix parameter of a neuron node, a bias parameter of the neuron node, an activation function parameter of the neuron node, a stride parameter, or a padding value parameter.

The model type parameter is used to indicate a type of the model for use by the terminal. In the case where one or more models are pre-stored in the terminal, the terminal may determine, based on the model type parameter, a target model to be used. The number of network layers is used to indicate the number of network layers of the model for use by the terminal. In the case where one or more network layer structures of the models are pre-stored in the terminal, the terminal may determine, based on the number of network layers, to select a combination of network layer structures corresponding to the number of network layers as the target model to be used. The number of neuron nodes in each network layer is used to indicate the number of neuron nodes in each network layer of the model for use by the terminal. The computation parameter matrix parameter of the neuron node is used to indicate a computation parameter matrix of the neuron node of the model for use by the terminal. The bias parameter of the neuron node is used to indicate a bias of the neuron node of the model for use by the terminal. The activation function parameter of the neuron node is used to indicate the activation function of the neuron node of the model for use by the terminal. The stride parameter is used to indicate a stride or strides of the model for use by the terminal. The padding value parameter is used to indicate the padding value of the model for use by the terminal.

In the exemplary embodiment, the model indication information sent by the access network device to the terminal includes model parameter information, and the model parameter information includes: a model type parameter and a computation parameter matrix parameter of a neuron node. In the embodiment of the present disclosure, a type of the model can be determined based on the model type parameter, and further, a computation parameter matrix of the neuron node of the model can be determined. For example, when the model type parameter indicates that the model is a convolutional neural network model, and the computation parameter matrix parameter of the neuron node is a convolution kernel, the convolution kernel of the convolutional neural network model can be determined.

It should be noted that for different model types, the required model parameter information may be different, and the above examples are only for illustrative purposes, and the embodiments of the present disclosure do not impose specific limitations thereon.

In some embodiments, S41, sending model indication information to the terminal, includes:
sending a broadcast message to the terminal, where the broadcast message includes the model indication information;
or, sending a unicast message to the terminal, where the unicast message includes the model indication information;
or, sending a multicast message to the terminal, where the multicast message includes the model indication information.

In these embodiments of the present disclosure, the terminal receives the model indication information sent by the access network device, and may receive the model indication information by receiving a broadcast message, a unicast message, or a multicast message of the access network device.

In the case where the terminal is a specific terminal, the access network device may send a unicast message to the terminal that is a specific terminal. In the case where the terminal belongs to a specific group of terminals, the access network device may send a multicast message to the terminal that belongs to the specific group of terminals, whereby the terminal may receive the model indication information sent by the access network device.

In some embodiments, sending the broadcast message to the terminal includes: sending a SIB to the terminal, where the SIB includes the model indication information.

The SIB of the access network device may be an existing SIB or a newly configured SIB. The newly configured SIB is used to send the model indication information.

In these embodiments of the present disclosure, the broadcast message of the access network device may be a SIB, and the terminal can obtain the model indication information by receiving the SIB.

In some embodiments, sending the unicast message or the multicast message to the terminal includes:
sending media access control control unit (MAC CE) signaling to the terminal, where the MAC CE signaling includes the model indication information;
or, sending radio resource control (RRC) signaling to the terminal, where the RRC signaling includes the model indication information;
or, sending downlink control information (DCI) signaling to the terminal, where the DCI signaling includes the model indication information.

In these embodiments of the present disclosure, the unicast message of the access network device may be MAC CE signaling, RRC signaling, or DCI signaling. After the MAC CE signaling, RRC signaling, or DCI signaling is received, the terminal can obtain the model indication information.

In some embodiments of the present disclosure, after the model indication information sent by the access network device is received, the terminal determines a target model to be used, and can further determine an effective time for the target model. The determination of the effective time by the terminal for the target model can be referred to the relevant descriptions of other embodiments and will not be repeated herein.

In some embodiments, the access network device receives an acknowledgement character (ACK) from the terminal in feedback of the MAC CE signaling, the RRC signaling, or the DCI signaling.

After the MAC CE signaling including the model indication information sent by the access network device is received, the terminal provides feedback by sending an acknowledgement character (ACK) to the access network device.

After the DCI signaling including the model indication information sent by the access network device is received, the terminal may perform Hybrid Automatic Repeat Request (HARQ)-ACK feedback and sends an acknowledgement character (ACK) to the access network device.

In some embodiments, the MAC CE signaling, RRC signaling, or DCI signaling carries an effective time parameter.

In these embodiments of the present disclosure, the MAC CE signaling, RRC signaling, or DCI signaling sent by the access network device carries an effective time parameter, so that the terminal, after receiving the MAC CE signaling, RRC signaling, or DCI signaling, can determine the effective time for the target model according to the effective time parameter. The specific implementations can be referred to the relevant description of the above embodiments, which will not be repeated here.

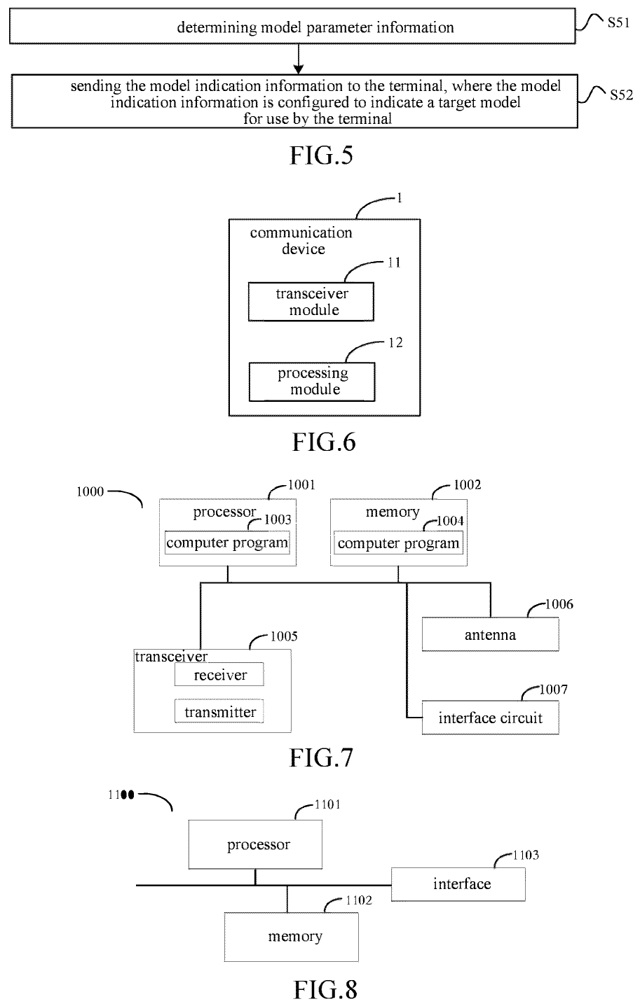

Referring to FIG. 5, FIG. 5 is a flowchart of yet another method for determining a model for use by a terminal provided by embodiments of the present disclosure.

As shown in FIG. 5, the method is applied to an access network device, and the method may include, but is not limited to, the following steps.

The first step S51 is determining model parameter information.

In some embodiments, the access network device receives the model parameter information sent by a core network device.

In these embodiments of the present disclosure, the access network device may receive the model parameter information sent by the core network device to further determine the model parameter information. It can be understood that an artificial intelligence model may be trained on the core network device, and the model parameter information may be sent to the access network device after the training of the artificial intelligence model is completed.

The next step S52 is sending the model indication information to the terminal, where the model indication information is configured to indicate a target model for use by the terminal.

It should be noted that the method for sending the model indication information from the access network device to the terminal can be referred to the relevant descriptions in the above embodiments and will not be repeated herein.

It should be noted that S51 and S52 may be implemented separately or in combination with any of the other steps in the embodiments of the present disclosure, such as in combination with S41 and S42 in the embodiments of the present disclosure, and the embodiments of the present disclosure do not limit this.

In the above-described embodiments provided in the present disclosure, the method provided in the embodiments of the present disclosure is described from the perspective of a terminal, and an access network device, respectively. In order to implement the functions in the method provided by the above embodiments of the present disclosure, the network device and the terminal may include a hardware structure and a software module. The above-described functions can be implemented in the form of hardware structures, software modules, or a combination of hardware structures and software modules. A function of the above-described functions may be performed in the form of a hardware structure, a software module, or a combination of a hardware structure and a software module.

Referring to FIG. 6, a schematic diagram of a structure of a communication device 1 provided by embodiments of the present application is shown. The communication device 1 shown in FIG. 6 may include a transceiver module 11 and a processing module. The transceiver module 11 may include a transmitter module and/or a receiver module. The transmitter module is used to implement a transmitting function, while the receiver module is used to implement a receiving function. The transceiver module 11 can implement the transmitting function and/or the receiving function.

The communication device 1 may be a terminal, or a device in a terminal, or a device capable of being matched for use with a terminal. Alternatively, the communication device 1 may be a network device, or a device in a network device, or a device capable of being matched for use with a network device.

The communication device 1 is a terminal 1 including a transceiver module 11 and a processing module 12.

The transceiver module 11 is configured to receive model indication information from an access network device.

The processing module 12 is configured to determine, based on the model indication information, a target model for use by the terminal.

In some embodiments, the processing module 12 is further configured to generate, in response to a presence of a first model currently used in the terminal, the target model by modifying the first model based on the model indication information.

In some embodiments, the first model is inherent to the terminal, or predefined, or generated based on model indication information last sent by the access network device, or obtained through training by the terminal, or obtained through joint training by the terminal and the access network device.

In some embodiments, the model indication information includes model parameter information, the model parameter information including at least one of the following:
a model type parameter;
a computation parameter matrix parameter of a neuron node;
a bias parameter of the neuron node;
an activation function parameter of the neuron node;
a stride parameter; or
a padding value parameter.

In some embodiments, the transceiver module 11 is specifically configured to:
receive a broadcast message of the access network device, where the broadcast message includes the model indication information;
or, receive a unicast message of the access network device, where the unicast message includes the model indication information;
or, receive a multicast message of the access network device, where the multicast message includes the model indication information.

In some embodiments, the transceiver module 11 is specifically configured to: receive a system information block (SIB) of the access network device, where the SIB includes the model indication information.

In some embodiments, the transceiver module 11 is specifically configured to:
receive media access control control unit (MAC CE) signaling of the access network device, where the MAC CE signaling includes the model indication information;
or, receive radio resource control (RRC) signaling of the access network device, where the RRC signaling includes the model indication information;
or, receive downlink control information (DCI) signaling of the access network device, where the DCI signaling includes the model indication information.

In some embodiments, the processing module 12 is further configured to determine an effective time for the target model, where the effective time is a time X plus N time units, the time X being a time when the model indication information is received from the access network device, N being greater than or equal to 0.

In some embodiments, the processing module 12 is further configured to determine an effective time for the target model, where the effective time is a first moment that occurs after a moment when the terminal sends an acknowledgement character (ACK) in feedback of the MAC CE signaling, the RRC signaling, or the DCI signaling plus a preset length of time.

In some embodiments, the processing module 12 is further configured to:
determine an effective time for the target model based on an effective time parameter and a time when the MAC CE signaling is received, where the MAC CE signaling carries the effective time parameter;
or, determine an effective time for the target model based on an effective time parameter and a time when the RRC signaling is received, where the RRC signaling carries the effective time parameter;
or, determine an effective time for the target model based on an effective time parameter and a time when the DCI signaling is received, where the DCI signaling carries the effective time parameter.

The communication device 1 is an access network device including a transceiver module 11.

The transceiver module 11 is configured to send model indication information to a terminal, where the model indication information is configured to indicate a target model for use by the terminal.

In some embodiments, the model indication information includes model parameter information, the model parameter information including at least one of:
a model type parameter;
a computation parameter matrix parameter of a neuron node;
a bias parameter of the neuron node;
an activation function parameter of the neuron node;
a stride parameter; or
a padding value parameter.

In some embodiments, the transceiver module 11 is specifically configured to:
send a broadcast message to the terminal, where the broadcast message includes the model indication information;
or, send a unicast message to the terminal, where the unicast message includes the model indication information;
or, send a multicast message to the terminal, where the multicast message includes the model indication information.

In some embodiments, the transceiver module 11 is specifically configured to:
send a SIB to the terminal, where the SIB includes the model indication information.

In some embodiments, the transceiver module 11 is specifically configured to:
send media access control control unit (MAC CE) signaling to the terminal, where the MAC CE signaling includes the model indication information;
or, send radio resource control (RRC) signaling to the terminal, where the RRC signaling includes the model indication information;
or, send downlink control information (DCI) signaling to the terminal, where the DCI signaling includes the model indication information.

In some embodiments, the transceiver module 11 is further configured to receive an acknowledgement character (ACK) from the terminal in feedback of the MAC CE signaling, the RRC signaling, or the DCI signaling.

In some embodiments, the MAC CE signaling, the RRC signaling, or the DCI signaling carries an effective time parameter.

In some embodiments, the communication device further includes a processing module 12 configured to determine model parameter information.

In some embodiments, the transceiver module 11 is further configured to receive the model parameter information from a core network device.

With regard to the communication device 1 in the above embodiments, the specific manner in which each module performs an operation has been described in detail in the embodiments relating to the method, and will not be described in detail here.

The communication device 1 provided in the above embodiments of the present disclosure achieves the same or similar beneficial effects as the communication methods provided in some of the above embodiments, and will not be repeated herein.

Referring to FIG. 7, FIG. 7 is a schematic diagram of a structure of another communication device 1000 provided by embodiments of the present disclosure. The communication device 1000 may be an access network device or a terminal, or may be a chip, chip system, or processor, etc. that supports the access network device to implement the above-described methods, or may be a chip, chip system, or processor, etc. that supports the terminal to implement the above-described methods. The communication device 1000 may be used to implement the methods described in the above method embodiments, and specific details can be referred to the descriptions of the above method embodiments.

The communication device 1000 may be an access network device or a terminal, or may be a chip, chip system, or processor, etc. that supports the access network device to implement the above-described methods, or may be a chip, chip system, or processor, etc. that supports the terminal to implement the above-described methods. The device may be used to implement the methods described in the above method embodiments, and specific details can be referred to the descriptions of the above method embodiments.

The communication device 1000 may include one or more processors 1001. The processor 1001 may be a general-purpose processor or a specific-purpose processor, etc. For example, it may be a baseband processor or a central processor. The baseband processor may be used to process communication protocols as well as communication data. The central processor may be used to control a communication device (e.g., a base station, baseband chip, terminal, terminal chip, DU or CU, etc.), execute a computer program, and process data of the computer program.

Optionally, one or more memories 1002 may also be included in the communication device 1000, on which a computer program 1004 may be stored. The processor 1001 executes the computer program 1004 to cause the communication device 1000 to perform the method described in the method embodiments above. Optionally, data may also be stored in the memory 1002. The communication device 1000 and the memory 1002 may be provided separately or may be integrated together.

Optionally, the communication device 1000 may further include a transceiver 1005 and an antenna 1006. The transceiver 1005 may be referred to as a transceiver unit, a transceiver machine, or a transceiver circuit, etc., for implementing receiving and transmitting functions. The transceiver 1005 may include a receiver and a transmitter. The receiver, which can also be referred to as a receiving machine or a receiving circuit, etc., is used to implement receiving functions. The transmitter, which can also be referred to as a transmitting machine or a transmitting circuit, etc., is used to implement transmitting functions.

Optionally, one or more interface circuits 1007 may also be included in the communication device 1000. The interface circuits 1007 are used to receive code instructions and transmit them to the processor 1001. The processor 1001 runs the code instructions to cause the communication device 1000 to perform the method described in the above method embodiments.

When the communication device 1000 is a terminal, the transceiver 1005 is used to perform S21 in FIGS. 2 and S31 in FIG. 3; and the processor 1001 is used to perform S22 in FIGS. 2 and S32 in FIG. 3.

When the communication device 1000 is an access network device, the transceiver 1005 is used to perform S41 in FIGS. 4 and S52 in FIG. 5; and the processor 1001 is used to perform S51 in FIG. 5.

In one implementation, the processor 1001 may include a transceiver for implementing the receiving and transmitting functions. The transceiver may be, for example, a transceiver circuit, or an interface, or an interface circuit. The transceiver circuit, interface, or interface circuit for implementing the receiving and transmitting functions may be separate or may be integrated together. The transceiver circuit, interface, or interface circuit described above may be used for code/data reading and writing, or, the transceiver circuit, interface, or interface circuit described above may be used for signal transmission or delivery.

In one implementation, the processor 1001 may hold a computer program 1003, which runs on the processor 1001 and may cause the communication device 1000 to perform the methods described in the method embodiments above. The computer program 1003 may be solidified in the processor 1001, in which case the processor 1001 may be implemented by hardware.

In one implementation, the communication device 1000 may include circuits which can implement the functions of sending or receiving or communicating in the preceding method embodiments. The processor and transceiver described in the present disclosure can be implemented on an integrated circuit (IC), analog IC, radio frequency integrated circuit (RFIC), mixed-signal IC, application specific integrated circuit (ASIC), printed circuit board (PCB), electronic device, etc. These processor and transceiver can also be manufactured using various IC process technologies, such as complementary metal oxide semiconductor (CMOS), n-type metal-oxide-semiconductor (NMOS), positive channel metal oxide semiconductor (PMOS), bipolar junction transistor (BJT), bipolar CMOS (BiCMOS), silicon-germanium (SiGe), or gallium arsenide (GaAs), etc.

The communication device in the above description of embodiments may be a terminal, but the scope of the communication device described in the present disclosure is not limited thereto, and the structure of the communication device may not be limited by FIG. 7. The communication device may be a stand-alone device or may be part of a larger device. For example the described communication device may be:
(1) A stand-alone integrated circuit IC, chip, chip system, or subsystem;
(2) A collection having one or more ICs, optionally, the collection of ICs may also include storage components for storing data, computer programs;
(3) An ASIC, such as a modem;
(4) A module that can be embedded in other equipment;
(5) A receiver, terminal, intelligent terminal, cellular phone, wireless device, handheld device, mobile unit, in-vehicle device, network device, cloud device, artificial intelligence device, and so on;
(6) Others, etc.

For the case where the communication device may be a chip or a chip system, see FIG. 8 for a structural diagram of a chip provided by embodiments of the present disclosure.

The chip 1100 includes a processor 1101 and an interface 1103. There may be one or more processors 1101 and one or more interfaces 1103.

For the case where the chip is used to implement the functions of the terminal in the embodiments of the present disclosure:
the interface 1103 is configured to receive code instructions and transmit them to the processor; and
the processor 1101 is configured to run code instructions to perform the method for determining a model for use by a terminal as described in some of the above embodiments.

For the case where the chip is used to implement the functions of the access network device in the embodiments of the present disclosure:
the interface 1103 is configured to receive code instructions and transmit them to the processor; and
the processor 1101 is configured to run code instructions to perform the method for determining a model for use by a terminal as described in some of the above embodiments.

Optionally, the chip 1100 further includes a memory 1102, the memory 1102 being used to store necessary computer programs and data.

Those of skill in the art may also appreciate that the various illustrative logical blocks and steps set forth in embodiments of the present disclosure may be implemented by electronic hardware, computer software, or a combination of both. Whether such functionality is implemented by hardware or software depends on the particular application and the design requirements of the overall system. Those skilled in the art may, for each particular application, use various methods to implement the described functionality, but such implementations should not be construed as being beyond the scope of protection of the embodiments of the present disclosure.

Embodiments of the present disclosure also provide a communication system including a communication device as a terminal and a communication device as an access network device in the aforementioned embodiment of FIG. 6, or, alternatively, the system includes a communication device as a terminal and a communication device as an access network device in the aforementioned embodiment of FIG. 7.

The present disclosure also provides a readable storage medium having stored thereon instructions which, when executed by a computer, implement the functions of any of the method embodiments described above.

The present disclosure also provides a computer program product that, when executed by a computer, implements the functionality of any of the method embodiments described above.

In the above embodiments, the implementation can be entirely or partially achieved through software, hardware, firmware, or any combination thereof. When implemented using software, it can be entirely or partially realized in the form of computer program products. The computer program products include one or more computer programs. When the computer programs are loaded and executed on a computer, they generate the processes or functions described in the embodiments of this disclosure, either entirely or partially. The computer can be a general-purpose computer, a special-purpose computer, a computer network, or another programmable device. The computer programs can be stored in a computer-readable storage medium or transmitted from one computer-readable storage medium to another. For example, the computer programs can be transmitted from one website, computer, server, or data center to another website, computer, server, or data center via wired (such as coaxial cable, optical fiber, digital subscriber line (DSL)) or wireless (such as infrared, radio, microwave, etc.) means. The computer-readable storage medium can be any accessible medium that a computer can access or a data storage device such as a server or data center that integrates one or more accessible mediums. The accessible medium can be a magnetic medium (e.g., floppy disk, hard disk, magnetic tape), an optical medium (e.g., digital video disc (DVD)), or a semiconductor medium (e.g., solid state disk (SSD)).

A person of ordinary skill in the art may understand that the “first,” “second,” and other various numerical numbers involved in the present disclosure are only described for the convenience of differentiation, and are not used to limit the scope of the embodiments of the present disclosure, and also not used to indicate the order of precedence.

The “at least one” in the present disclosure may also be described as “one or more,” and the term “plurality” refers to two, three, four, or more, without limitation by the present disclosure. In the embodiments of the present disclosure, for one type of technical features, technical features in this type are described by “first”, “second”, “third”, “A”, “B”, “C”, and “D”, etc., for the purpose of differentiation. The technical features described by “first”, “second”, “third”, “A”, “B”, “C”, and “D” have no order of priority or size.

The correspondences shown in the tables in this disclosure may be configured or may be predefined. The values of the information in the respective tables are merely examples and may be configured to other values, which are not limited by the present disclosure. In configuring the correspondence between the information and the respective parameters, it is not necessarily required that all of the correspondences illustrated in the respective tables must be configured. For example, the correspondences illustrated in certain rows of the tables in the present disclosure may also not be configured. For example, the above tables may be adjusted by appropriate distortions, such as splitting, merging, and the like. The names of the parameters shown in the headings in the above tables may also be other names understandable by the communication device, and the values or representations of the parameters thereof may also be other values or representations understandable by the communication device. The above tables may also be implemented using other data structures, such as arrays, queues, containers, stacks, linear tables, pointers, chain lists, trees, graphs, structures, classes, heaps, hash tables, or other structures.

The term “predefined” in this disclosure may be understood as “defined”, “pre-defined”, “stored”, “pre-stored”, “pre-negotiated”, “pre-configured”, “cured”, or “pre-fired”.

Those of ordinary skill in the art may realize that the units and algorithmic steps of the various examples described in conjunction with the embodiments disclosed herein are capable of being implemented in electronic hardware, or a combination of computer software and electronic hardware. Whether these functions are performed in hardware or software depends on the particular application and design constraints of the technical solution. The skilled professional may use different methods to implement the described functions for each particular application, but such implementations should not be considered beyond the scope of the present disclosure.

It can be clearly understood by those skilled in the field to which it belongs that, for the convenience and brevity of the description, the specific working processes of the above-described systems, devices, and units can be referred to the corresponding processes in the foregoing embodiments of the method, and will not be repeated herein.

The above description is only the specific implementation of the present disclosure, but the scope of protection of the present disclosure is not limited thereto. Any person skilled in the art who is familiar with the technical field can easily conceive of changes or substitutions within the technical scope disclosed in the present disclosure, which shall be covered by the scope of protection of the present disclosure. Therefore, the scope of protection of the present disclosure shall be subject to the scope of protection of the claims.

1. A method for determining a model for use by a terminal, performed by the terminal, the method comprising:
receiving model indication information from an access network device; and
determining, based on the model indication information, a target model for use by the terminal.

2. The method of claim 1, further comprising:
generating, in response to a presence of a first model currently used in the terminal, the target model by modifying the first model based on the model indication information.

3. The method of claim 2, wherein the first model is inherent to the terminal, or predefined, or generated based on model indication information last sent by the access network device, or obtained through training by the terminal, or obtained through joint training by the terminal and the access network device.

4. The method of claim 1, wherein the model indication information comprises model parameter information, the model parameter information comprising at least one of:
a model type parameter;
a computation parameter matrix parameter of a neuron node;
a bias parameter of the neuron node;
an activation function parameter of the neuron node;
a stride parameter; or
a padding value parameter.

5. The method of claim 1, wherein receiving the model indication information from the access network device comprises:
receiving a broadcast message of the access network device, wherein the broadcast message comprises the model indication information;
or, receiving a unicast message of the access network device, wherein the unicast message comprises the model indication information;
or, receiving a multicast message of the access network device, wherein the multicast message comprises the model indication information.

6. The method of claim 5, wherein receiving the broadcast message of the access network device comprises:
receiving a system information block (SIB) of the access network device, wherein the SIB comprises the model indication information;
or, wherein receiving the unicast message or multicast message of the access network device comprises one of:
receiving media access control control unit (MAC CE) signaling of the access network device, wherein the MAC CE signaling comprises the model indication information;
receiving radio resource control (RRC) signaling of the access network device, wherein the RRC signaling comprises the model indication information; or
receiving downlink control information (DCI) signaling of the access network device, wherein the DCI signaling comprises the model indication information.

7. (canceled)

8. The method of claim 1, further comprising:
determining an effective time for the target model, wherein the effective time is a time X plus N time units, the time X being a time when the model indication information is received from the access network device, N being greater than or equal to 0, the time unit being one of: second, millisecond, microsecond, frame, subframe, slot, mini-slot, or symbol.

9. The method of claim 6, further comprising:
determining an effective time for the target model, wherein the effective time is a first moment that occurs after a moment when the terminal sends an acknowledgement character (ACK) in feedback of the MAC CE signaling, the RRC signaling, or the DCI signaling plus a preset length of time;
or, determining an effective time for the target model based on an effective time parameter and a time when the MAC CE signaling is received, wherein the MAC CE signaling carries the effective time parameter;
or, determining an effective time for the target model based on an effective time parameter and a time when the RRC signaling is received, wherein the RRC signaling carries the effective time parameter;
or, determining an effective time for the target model based on an effective time parameter and a time when the DCI signaling is received, wherein the DCI signaling carriers the effective time parameter.

10. (canceled)

11. A method for determining a model for use by a terminal, performed by an access network device, the method comprising:
sending model indication information to the terminal, wherein the model indication information is configured to indicate a target model for use by the terminal.

12. The method of claim 11, wherein the model indication information comprises model parameter information, the model parameter information comprising at least one of:
a model type parameter;
a computation parameter matrix parameter of a neuron node;
a bias parameter of the neuron node;
an activation function parameter of the neuron node;
a stride parameter; or
a padding value parameter.

13. The method of claim 11, wherein sending the model indication information to the terminal comprises:
sending a broadcast message to the terminal, wherein the broadcast message comprises the model indication information;
or, sending a unicast message to the terminal, wherein the unicast message comprises the model indication information;
or, sending a multicast message to the terminal, wherein the multicast message comprises the model indication information.

14. The method of claim 13, wherein sending the broadcast message to the terminal comprises:
sending a system information block (SIB) to the terminal, wherein the SIB comprises the model indication information;
or, sending the unicast message or multicast message to the terminal comprises one of:
sending media access control control unit (MAC CE) signaling to the terminal, wherein the MAC CE signaling comprises the model indication information;
sending radio resource control (RRC) signaling to the terminal, wherein the RRC signaling comprises the model indication information; or
sending downlink control information (DCI) signaling to the terminal, wherein the DCI signaling comprises the model indication information.

15. (canceled)

16. The method of claim 14, further comprising:
receiving an acknowledgement character (ACK) from the terminal in feedback of the MAC CE signaling, the RRC signaling, or the DCI signaling.

17. The method of claim 14, wherein the MAC CE signaling, the RRC signaling, or the DCI signaling carries an effective time parameter.

18. The method of claim 11, further comprising:
determining model parameter information.

19. The method of claim 18, further comprising:
receiving the model parameter information from a core network device.

20. (canceled)

21. (canceled)

22. A communication device, comprising a processor and a memory in which a computer program is stored, wherein the processor executes the computer program stored in the memory to cause the communication device to perform the method of claim 1.

23. (canceled)

24. A non-transitory computer-readable storage medium for storing instructions which, when executed by a processor, cause the processor to perform the method of claim 1.

25. The method of claim 2, wherein the model indication information comprises model parameter information, the model parameter information comprising at least one of:
a model type parameter;
a computation parameter matrix parameter of a neuron node;
a bias parameter of the neuron node;
an activation function parameter of the neuron node;
a stride parameter; or
a padding value parameter.

26. The method of claim 2, wherein receiving the model indication information from the access network device comprises:
receiving a broadcast message of the access network device, wherein the broadcast message comprises the model indication information;
or, receiving a unicast message of the access network device, wherein the unicast message comprises the model indication information;
or, receiving a multicast message of the access network device, wherein the multicast message comprises the model indication information.
